(19) United States
(12) Patent Application Publication
(10) Pub. No.: US 2001/0046409 A1
(43) Pub. Date: Nov. 29, 2001

(54) Connector assembly

(76) Inventor: Roy K. Fischer, Scottsdale, AZ (US)

Correspondence Address: Gregory J. Nelson, NELSON & ROEDIGER, Suite 212, 3333 E. Camelback Road, Phoenix, AZ, 85018, US

(21) Appl. No.: 09/785,013

(22) Filed: Feb. 16, 2001

Related U.S. Application Data
(60) Provisional application No. 60/183,550, filed on Feb. 18, 2000.

(51) Int. Cl. F16D 1/12; F16D 3/00; F16C 11/00

(52) U.S. Cl. 403/92

(57) ABSTRACT

A connector assembly for securing a device such as a cell phone to a mounting surface to provide a full range of motion. The connector has a base plate rotatably connected to a pivot arm. The upper end of the pivot arm supports the device or a holder for the device. The rotatable connection comprises engageable gear rings having a low tooth profile which will “slip” in the event of a severe impact for safety and to prevent breakage. In a preferred embodiment, the connector gear rings are of a material having some flexibility to assist in providing slippage.

This application is based on provisional patent application No. 60/183,550, filed Feb. 18, 2000, entitled “Connector Assembly.”

### FIELD OF THE INVENTION

The present invention relates to a connector assembly more particularly to a connector assembly which provides a range of motion allowing a component to be adjustably secured to mounting surface.

### BACKGROUND OF THE INVENTION

There are numerous applications where a device is required to be adjustably secured to another or to a mounting surface. One such application is the attachment of a holder for an electronic device to a surface to allow the holder to be variously positioned in accordance with the requirements of the user. For example, cell phone holders are becoming increasingly more common in automobiles. Generally it is required that the holder be secured in a location easily accessible by the driver. Often the surface on which the holder is required to be mounted is the console or dashboard of the vehicle convenient for the user so the holder is at a location that can both be easily seen and accessed by the driver. Therefore, the connector attaching the holder to the mounting surface of the automobile must provide a full range of motion to allow the holder to be selectively positioned so the cell phone is positioned in a convenient accessible position.

### SUMMARY OF THE INVENTION

Briefly the present invention provides a universal connector assembly having a base plate which carries teeth arranged in ring pattern. A lower bracket plate carrying mating teeth is rotatably secured to the base plate by a fastener so that the fastener may be loosened and the relative position of the base plate to the plate may be rotatively adjusted. The mating teeth on the mounting plate and lower bracket have a shallow pitch angle which allows the mating teeth to disengage in the event of a severe impact.

The lower bracket plate carries one component of a hinge or pivot which includes several upstanding tabs which extend into slots on a bracket arm assembly. A bore extends through the arm and the tabs and receives a fastener. Accordingly, the angular position of the bracket arm with respect to the base plate can be adjusted by loosening the fastener and positioning the arm in the desired position and retightening the fastener. The upper end of the arm carries an upper bracket plate also having a circular array of teeth similar to that on the lower base plate. These teeth interface with cooperative teeth on a device to be mounted or on a mounting plate which may be attached to the device. The rotational adjustability at the upper and lower bracket plates and the angular adjustability on the arm allow a full range of motion so a device secured to the upper mounting plate can be selectively positioned for the convenience of the user.

### BRIEF DESCRIPTION OF THE DRAWINGS

The above and other objects of the invention will be more fully understood from the following description and drawings in which:

FIG. 1 is a front exploded view of the connector assembly of the present invention;

FIG. 2 is a rear exploded view of the connector assembly of the present invention;

FIG. 3 is a side view of the connector showing a holder attached to the upper end of the arm;

FIG. 4 is a detail view representative of the teeth on the base, mounting plate and upper and lower bracket plates;

FIG. 5 is a detail view representative of the tooth profile;

FIG. 6 is a plan view of the gear teeth ring on the base, mounting plate and bracket plates.

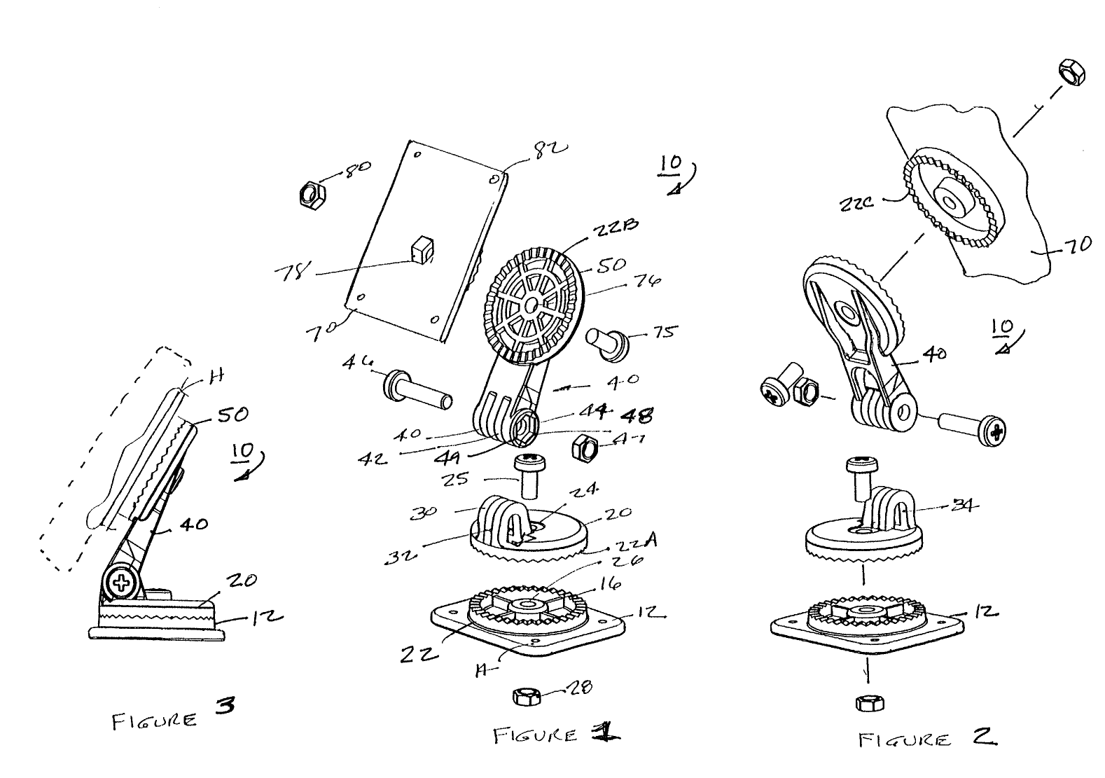

### DETAILED DESCRIPTION OF THE DRAWINGS

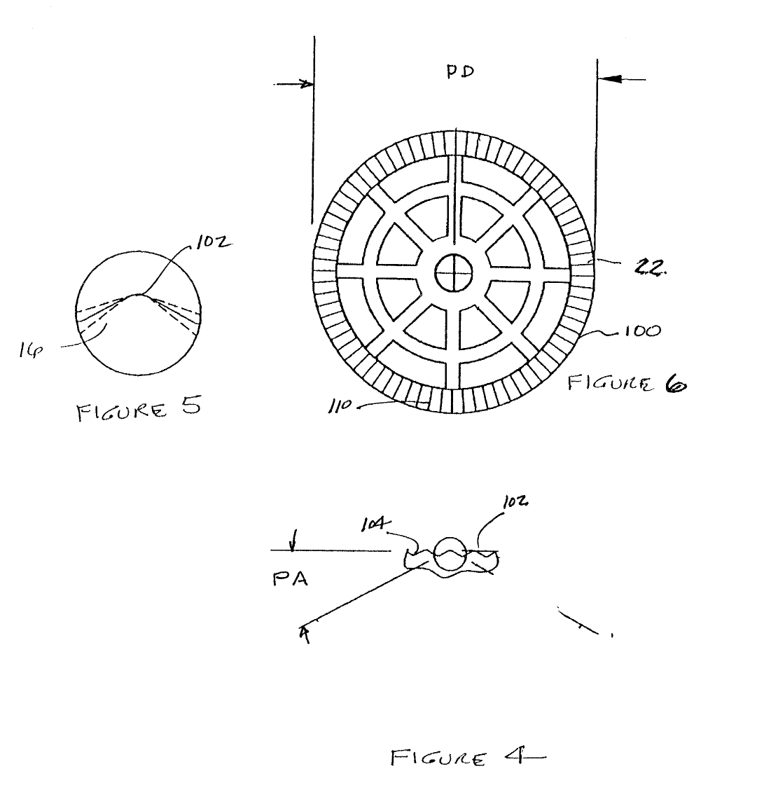

Turning to the drawings, the connector assembly is generally designated by the numeral 10 and has a lower base plate 12. The lower base plate 12 may be any suitable configuration and is shown as being generally square having holes 14 to allow it to be secured by fasteners to a suitable mounting surface. The upper surface of the base plate carries teeth 16 which are integrally formed therewith. The teeth 16, as best seen in FIGS. 4 to 6 consist of a plurality of teeth arranged in a ring 22 with each tooth 16 having a shallow tooth profile preferably at a low pitch angle below 45°. Further, the teeth and the base between teeth that are slightly rounded at 102 and 104 to provide controlled slippage in the event of impact and as will be explained more fully hereafter.

A cooperating lower bracket plate 20 carries a gear tooth ring 22A which is engageable and cooperates with the gear tooth ring 22 on the base plate. The lower bracket plate defines a center opening 24 which aligns with the central opening 26 in the base plate which receive a fastener 25 which is shown as a threaded and which receives a nut 28. Thus, the relative rotative position of the lower bracket plate 20 and base plate 12 can be selectively adjusted by loosening the fastener 25 and rotating the components relative to one another and retightening the fastener.

The upper surface of the lower bracket plate 20 carries a pivot connection which consists of spaced-apart upstanding projections 30 and 32 which each define an aligned horizontally extending opening 34. A bracket arm assembly 40 defines slots 42 and 44 at its lower end which receive the upstanding projections 30, 32 on the lower bracket plate 20. The arm defines a transverse bore 48 which aligns with the bore 34 in the projections. The aligned projections receive a fastener 46 which receives a hexagonal nut 47 at its opposite end. The nut is captured within a hexagonal recess 49 in the bracket arm. It will be apparent that by loosening the fastener, the angle or position of the arm 40 with respect to the lower bracket plate can be selectively adjusted and the nut 47 will be restrained from rotating.

The upper end of the arm 40 carries an upper bracket plate 50 which is similar construction to the lower bracket plate but is fixed to the arm. The upper bracket plate carries a gear tooth ring 22B arranged and configured as seen in FIG. 4 to 6. An upper mounting plate 70 which is shown as being generally square also carries a gear tooth ring 22C which engages the teeth on the upper bracket plate. A fastener 75 extends through a central aperture 76 in the upper bracket plate and bore 78 the upper mounting plate receiving a nut 80 so that the upper bracket plate and mounting plate may be rotatively adjusted with respect to one another.

The teeth 22 to 22C which are integrally formed on the plates 12, 20 50 and 70 are shown in detail in FIGS. 4 to 6. The teeth are arranged on a pitch diameter PD and each has a profile as seen in FIG. 5 having a shallow pitch angle of less than 45° with the peaks 102 and base between adjacent teeth 104 rounded. The surface 110 of the individual teeth are radially aligned.

In use, a device such as a holder H for a telephone can be secured to the upper mounting plate 70 by suitable fasteners extending in the apertures 82 in the mounting plate 70 or the holder device H may be adhesively secured thereto. Alternatively, the holder or device may be provided with an array of teeth arranged in a ring to mate directly with the teeth 22C on the upper bracket plate 50. The lower base plate 12 is secured to a suitable location such as a console of an automobile. The base plate 12 may be adhesively secured or secured by fasteners extending through the mounting holes 14 provided at the four corners of the plate. The position of the attached device such as a cell phone can then be conveniently adjusted by rotating the lower mounting plate with respect to the lower bracket plate. Further adjustment can be made by rotating the position of the upper mounting plate 70 with respect to the upper bracket plate. Similarly, the position of the device can also be adjusted about the horizontal axis by loosening the fastener 46 and angularly adjusting the position of the bracket arm.

These adjustments provide the user a full range of motion to conveniently position a device such as a cell phone or other electronic device in a convenient position particularly when the surface to which the holder will be applied may vary considerably from vehicle to vehicle and the personal preferences of the user may vary considerably.

The connector assembly of the present invention is preferably manufactured from a suitable, somewhat flexible, material such as a plastic with glass filled polycarbonate being a preferred material. The device is universal, simple to install, simple to use and provides a wide range of motion for adjustability.

A further significant advantage resides in the teeth configuration which provides rotatable adjustment. As indicated above, a gear teeth ring arranged on the upper and lower plates and the upper and lower bracket plates have tooth profiles which are shallow and are slightly rounded. Thus, if the device is impacted, the shallow profile the teeth along with the flexible characteristics of the material provides a “clutching” effect which will allow slippage so as to minimize or prevent damage to the device and prevent harm to an occupant who may impact the device as a result of a traffic accident or other situation. The pivotal connection at the lower end of the bracket arm 40 also will allow the arm to collapse if struck since the inter-engaging components on the lower bracket and the lower end of the arm are smooth with providing only minimal frictional resistance to rotation. The engagement is sufficient to hold the stored device in the proper position during use, but if an abnormal impact occurs, the arm will collapse.

Another advantage of the invention is that the bracket arm 46 is relatively long providing a substantial “throw” increasing the positional adjustability of the device.

It will be obvious to those skilled in the art to make various modifications and changes to the connector device described herein. To the extent these changes do not depart from the spirit and scope of invention, they are to be encompassed therein.

1. A connector assembly comprising:
(a) a base plate securable to a mounting surface having an array of gear teeth thereon;
(b) a bracket assembly having an arm pivotally connected to a lower bracket plate;
(c) said lower bracket plate having an array of gear teeth thereon cooperatively engaging said array of teeth on said base plate; and
(d) an upper bracket plate on said arm having an array of gear teeth thereon whereas a device may be secured to said upper end of said bracket arm to provide a full range of motion.

2. The connector of claim 1 wherein said array of gear teeth on said base plate and said lower bracket plate comprise a plurality of teeth arranged on a pitch circle, said teeth each having a low profile to provide controlled slippage in the event of impact to prevent harm.

3. The connector of claim 2 wherein said teeth having a pitch angle of less than 45°.

4. The connector of claim 1 wherein said base plate is securable to a mounting surface by a fastener.

5. The connector of claim 1 wherein said base plate is securable to a mounting surface by an adhesive.

6. The connector of claim 2 wherein said arm is pivotal about an axis generally perpendicular to the axis of rotation of said pitch circle on said bracket plate.

7. The connector of claim 1 wherein said bracket plate and base plate are fabricated by a flexible material.

8. The connector of claim 1 wherein said upper bracket plate is provided with an array of gear teeth thereon.

9. The connector of claim 7 wherein said material is a glass filled polycarbonate.
